(19) United States
(12) Patent Application Publication
(10) Pub. No.: US 2023/0044550 A1
(43) Pub. Date: Feb. 9, 2023

(54) BARBECUE UTENSIL

(71) Applicant: BRANDIVISION GmbH, Düsseldorf (DE)

(72) Inventor: Dirk ZIMMERMANN, Düsseldorf (DE)

(21) Appl. No.: 17/881,909

(22) Filed: Aug. 5, 2022

(30) Foreign Application Priority Data
Aug. 8, 2021 (DE) 10 2021 121 475.0

(51) Int. Cl. A47J 43/28; A47J 37/07

(52) U.S. Cl. CPC A47J 43/288; A47J 37/0786; A47J 43/283; A47J 2037/0777

(57) ABSTRACT

A barbecue utensil having at least one tool which can be stowed in a housing, wherein preferably at least one tool is designed in the form of a foldable turner. A plurality of tools such as, for example, barbecue tongs, a bread knife and/or a fork can be combined with one another.

### CROSS-REFERENCE TO RELATED APPLICATIONS

The present application claims priority of DE 10 2021 121 475.0, filed Aug. 8, 2021, the priority of this application is hereby claimed, and this application is incorporated herein by reference.

### BACKGROUND OF THE INVENTION

The invention relates to a barbecue utensil having at least one tool which can be stowed in a housing of the barbecue utensil.

Similar arrangements are already known in the form of so-called multi-tools, which have different tools such as, for example, tongs, scissors, knives and/or saws integrated therein. It is usually the case here that a swing-action function allows the tools to be stowed in a housing of the multi-tool or swung out of the same for use purposes.

The core of the functionality of such multi-tools is that a single arrangement combines different tools in one housing, wherein the individual tools can be individually placed in position for use, for example by being swung out, and stowed in the housing for reliable transportation.

Specifically for uses in preparing food, such multi-tools are, indeed, also already known, but, up until now, they have been vastly restricted in respect of handling and functionality.

In some cases, for example where barbecuing or camping are concerned, food is prepared in situations in which it is not convenient for a large number of tools such as utensils and kitchen equipment to be brought along.

### SUMMARY OF THE INVENTION

It is therefore an object of the invention to specify a barbecue utensil in which, in a manner similar to a multi-tool, the transportation and handling of at least one tool is improved.

This object is achieved according to the invention by a barbecue utensil that has a housing, which can be used as a handle, and at least one tool which can be stowed in the housing.

In one embodiment of the barbecue utensil according to the invention, one tool is designed in the form of a foldable turner for the purpose of turning food, wherein the surface area of the head of the turner can be reduced with the aid of the folding function for stowage purposes and can be increased with the aid of the folding function in order for the turner to be used for the purpose of turning food. This allows the turner to be stowed in a space-saving manner.

In a preferred embodiment of the invention, the head of the turner has a plurality of head segments, which can be folded open and closed in a fan-like manner.

In a particularly preferred embodiment of the invention, the head segments are connected to one another via contact elements such that all the head segments can be fanned out by the actuation of a single head segment. This results in improvement in the handling of the turner during folding-open operations.

The head segments of the turner can advantageously be fixed in a fanned-out position with the aid of a fixing device. This makes it possible to prevent the situation where the head of the turner folds closed in an undesirable manner when the turner is being used.

A further embodiment of the invention provides for coupling of the head segments of the turner by a slide-actuation folding mechanism, so that the head of the turner can be folded open by the actuation of a slide.

In a further variant, the head of the turner can be folded open and closed in dependence on the sliding direction in which a slide is actuated.

In embodiments of the invention, the housing of the barbecue utensil has two main shells, which are designed in the form of U-shaped profiles and can be swung closed and swung open via at least one housing hinge, wherein these main shells, in a swung-closed state, form a stowage space for tools designed in the form of swing-action tools.

In an advantageous embodiment of the invention, the latter has a locking device, wherein, in a swung-closed state, the housing halves can be locked with the aid of the locking device, so that the housing can be secured against undesirable opening.

In preferred embodiments of the invention, a covering shell is arranged on the outside of at least one of the main shells in the swung-closed state of the housing, and this results in the formation, between the main shell and the covering shell fastened thereon, of a stowage space for a tool designed in the form of a sliding tool.

In preferred embodiments of the invention, the covering shell is connected to the respective main shell in a releasable manner with the aid of corresponding connecting means, and this makes it possible for a tool located therebeneath to be removed. This allows straightforward maintenance or the replacement of corresponding tools and also thorough cleaning of the barbecue utensil.

The connecting means are particularly preferably designed so as to achieve parallel movement of the covering shell in relation to the respective main shell when the covering shell is being connected or released. This is realized, in advantageous embodiments of the invention, by corresponding guide structures.

In embodiments of the invention, the barbecue utensil has at least one sliding tool designed in the form of a knife, a fork or a skewer.

A barbecue utensil according to the invention preferably has a sliding tool designed in the form of a knife and a sliding tool designed in the form of a fork or a skewer.

In other embodiments of the invention, the barbecue utensil can also be designed to accommodate a swing-action tool in at least one stowage space between a main shell and a covering shell.

In a preferred embodiment of the invention, the barbecue utensil has at least one arresting spring for at least one swing-action tool, wherein the arresting spring is prestressed so as to subject the respective swing-action tool to a force which acts in the direction of the swung-in position of the swing-action tool. A corresponding swing-action tool is thereby secured against undesirable swing-out operation.

In one embodiment of the invention, the barbecue utensil has a swing-action tool designed in the form of barbecue tongs.

In a preferred embodiment of the invention, the barbecue utensil has bearing shoulders for the central alignment of the tongs in the swung-closed state of the barbecue tool.

Examples of further conceivable swing-action tools of a barbecue utensil according to the invention are knives, can openers and/or bottle openers.

Use of a barbecue utensil according to the invention, of course, is not restricted to barbecuing. Rather, the concept according to the invention can be generally applied to kitchen equipment, so that the latter can be reliably transported in a space-saving manner, in particular, for mobile use.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1: shows a perspective illustration of an embodiment of a barbecue utensil according to the invention,

FIG. 2: shows a side view of the embodiment of the barbecue utensil according to the invention,

FIG. 3: shows a plan view of the embodiment of the barbecue utensil according to the invention,

FIG. 4: shows a view from beneath the embodiment of the barbecue utensil according to the invention,

FIG. 5: shows a side view of a main shell of the housing of the embodiment of the barbecue utensil according to the invention,

FIG. 6: shows a front view of the main shell according to FIG. 5,

FIG. 7: shows a side view of a covering shell of the housing of the embodiment of the barbecue utensil according to the invention,

FIG. 8: shows a front view of the covering shell according to FIG. 7,

FIG. 9: shows a perspective view of a housing half formed from a main shell and a covering shell,

FIG. 10: shows a perspective view of the embodiment of the barbecue utensil according to the invention with sliding tools pulled out,

FIG. 11: shows a perspective view of the embodiment of the barbecue utensil according to the invention with swing-action tools partially swung out,

FIG. 12: shows a detail-specific view of a partially assembled barbecue utensil according to the invention in the region of a swing-action tool,

FIG. 13: shows a perspective view of the embodiment of the barbecue utensil according to the invention with a turner, forming a swing-action tool, partially swung out,

FIG. 14: shows a perspective view of the embodiment of the barbecue utensil according to the invention in a partially dismantled state with the turner swung out and fanned out, and

FIGS. 15a-c: show perspective views of the turner in the folded-closed state (FIG. 14a), when it is being folded open (FIG. 14b) and in the folded-open state (FIG. 14c).

### DETAILED DESCRIPTION OF THE INVENTION

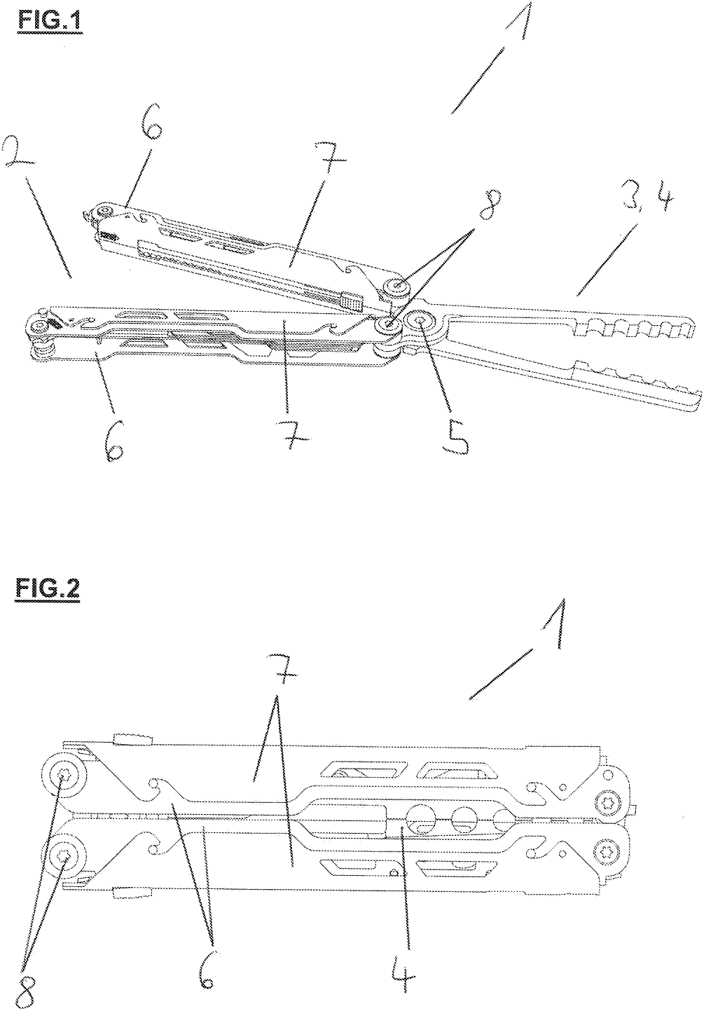

FIG. 1 illustrates a perspective view of an embodiment of a barbecue utensil (1) according to the invention.

The housing (2) of the barbecue utensil (1) has been swung open, so that it is possible to use a tool (3) designed in the form of barbecue tongs (4). The barbecue tongs (4) have a spring-mounted articulation pin (5), wherein the spring-mounting function opens the barbecue tongs (4). This means that, when the barbecue tongs (4) are being used, there is no need for them to be gripped fully by hand in order to change over between opening operation and closing operation of the barbecue tongs (4).

The housing (2) is subdivided into two housing halves, which form the limbs of the handle of the barbecue tongs (4).

Each housing half has a main shell (6) and a covering shell (7), wherein the housing halves can be swung via a respective housing hinge (8) in order for the housing (2) to be opened or closed.

FIG. 2 shows a side view of that embodiment of a barbecue utensil (1) according to the invention which is shown in FIG. 1, this time in a swung-closed state. The barbecue tongs (4) have been positioned between the housing halves, within the main shells (6).

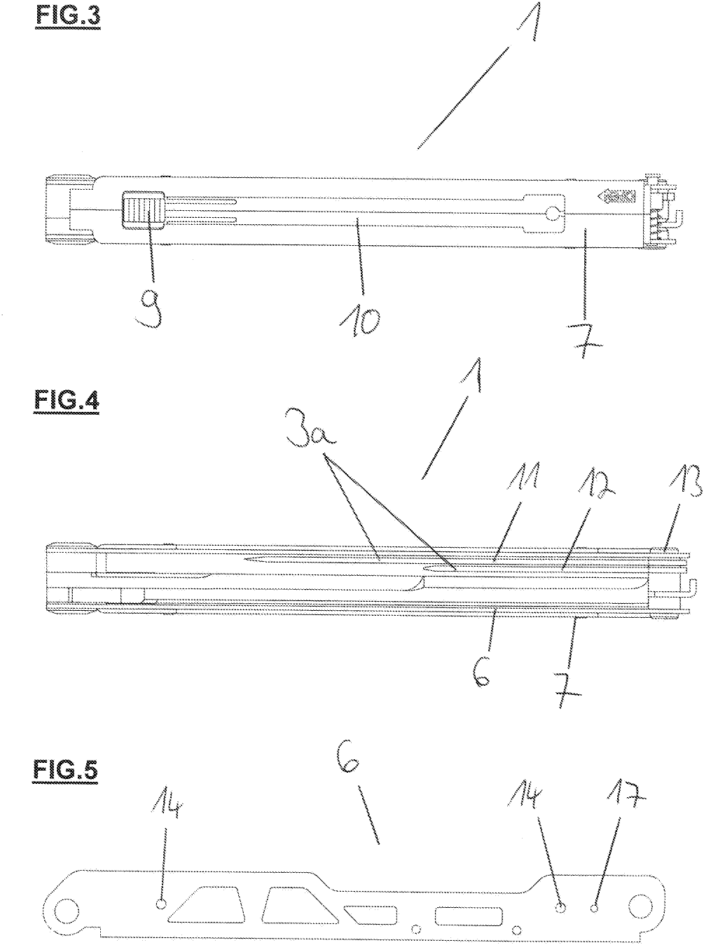

FIG. 3 shows a plan view of the embodiment of a barbecue utensil (1) according to the invention. It is possible to see the slide (9) of a tool (3) designed in the form of a sliding tool (3b), the sliding tool (3b) being in a state in which it has been pushed into the housing (2).

In the covering shell (7) a linear guide (10) is realized by an elongate opening, which at each of its ends has a latching point for the purpose of fixing the sliding tool (3b) in the respective position.

FIG. 4 illustrates the barbecue utensil (1) in a swung-open state, this making it possible for further swing-action tools (3a) to be reached.

The swing-action tools (3a) are designed in the form of a knife (11) and of a can and bottle opener (12) and can be swung over via a common axis-of-rotation element (13).

In a swung-open state, the swing-action tools (3a) are located within a main shell (6) of the housing (2).

FIG. 5 shows a side view of an embodiment of a main shell (6), and FIG. 7 shows a side view of a covering shell (7), of a barbecue utensil (1) according to the invention.

For the purpose of connecting the main shell (6) and covering shell (7), these two shells have releasable connecting means. In the present case, they are designed in the form of two studs (14) on the main shell (6), it being possible for the studs to be introduced into corresponding openings in the covering shell (7), the openings here being realized by two guide slots which each form a hook (16), and of a snap-fit or latching-action locking means. The latching-action locking means is formed by a latching element (17), which projects out of the surface of the main shell (6) and, for connection to a covering shell (7), latches or snaps into a corresponding opening (18).

This arrangement makes it possible, when the main shell (6) is being connected to the covering shell (7) or released therefrom, to achieve precise and accurate movement of the two shells in relation to one another as a result of the guiding function realized at four positions and therefore in all the end regions.

The guide slots have a respectively parallel first portion, which runs obliquely upward. This means that when the covering shell (7) is being released from the main shell (6), by virtue of the covering shell (7) being subjected to a force in the direction parallel to the longitudinal side of the main shell (6), the covering shell is moved out of the latching point of the connecting means and away from the main shell (6).

In the end region, the guide slots each have a portion which runs approximately parallel to the longitudinal side of the main shell (6). If the corresponding studs (14) have been guided into this region, the covering shell (7) can only be displaced parallel to the main shell (6), without any change in the distance between the covering shell (7) and main shell (6).

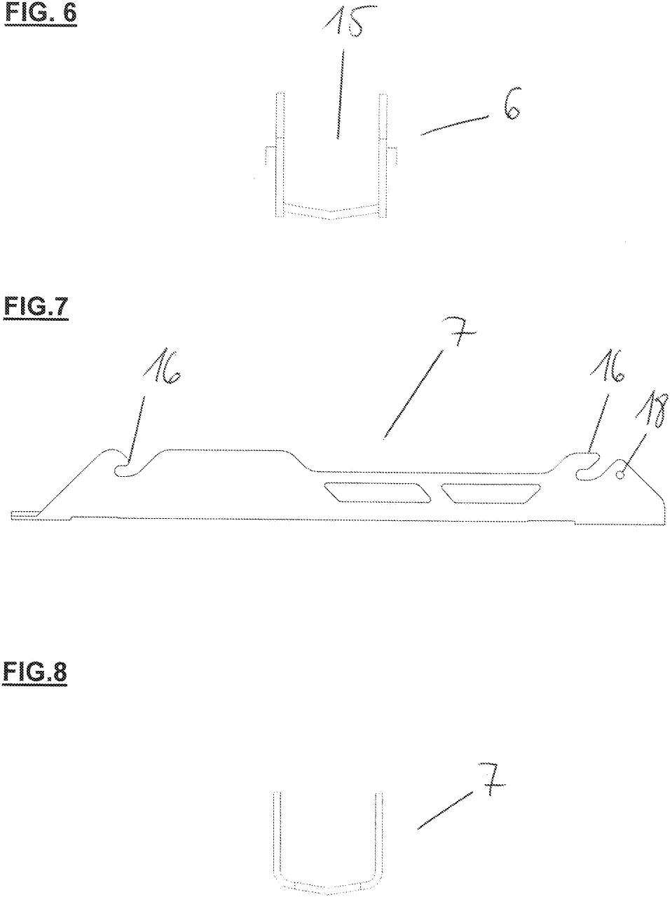

FIGS. 6 and 8 illustrate front views of a main shell (6) and of a covering shell (7), respectively, wherein it can be seen that these two shells are each designed in the form of a U-shaped profile.

A first stowage space (15) of a barbecue utensil (1) according to the invention is bounded by the U-shaped profiles of two oppositely located main shells (6).

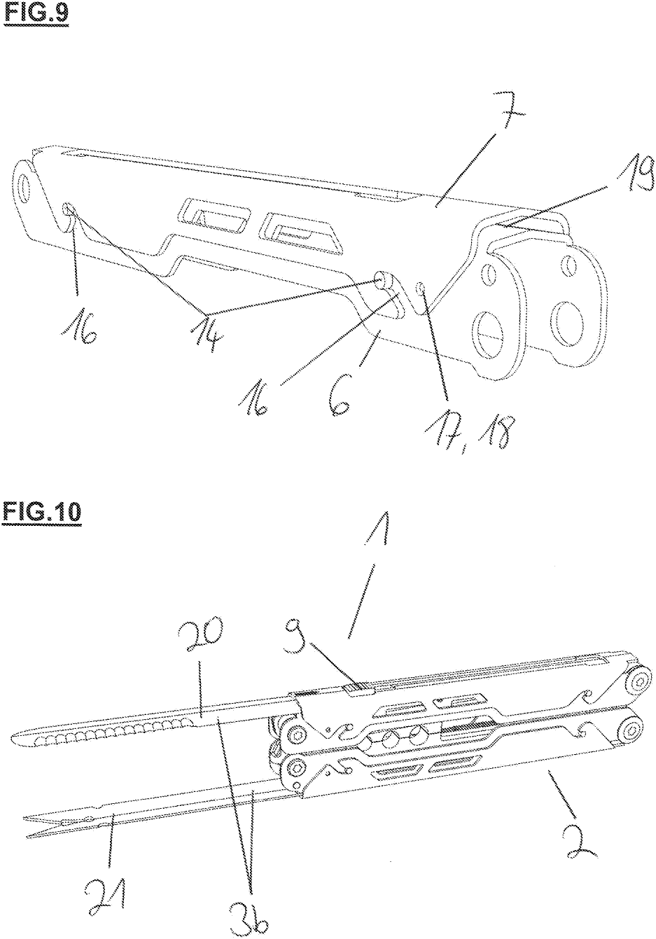

FIG. 9 shows a housing half of a barbecue utensil (1) according to the invention, wherein a main shell (6) and a covering shell (7) by connecting means corresponding to the explanations relating to FIGS. 5 to 8.

It can be seen here that the main shell (6) has been connected to the covering shell (7) such that these two shells are spaced apart from one another on the outside (in this case at the top), and this results in the formation of an interspace. The latter can be used as a second stowage space (19), in which for example sliding tools (3b) or swing-action tools (3a) can be arranged.

FIG. 10 illustrates a perspective view of the embodiment of a barbecue utensil (1) according to the invention with two sliding tools (3b) pulled out. A first sliding tool (3b) here is designed in the form of a sliding knife (20), in particular in the form of a bread knife, and a second sliding tool (3b) is designed in the form of a fork (21).

In accordance with the description above, a slide (9) can be used to slide the sliding tools (3b) out of the housing (2) for use purposes or to slide the same into the housing (2) for stowage purposes.

FIG. 11 shows a barbecue utensil (1) according to the invention in a partially open position with, forming the swing-action tools (3a), a fully swung-out knife (11) and a partially swung-out can and bottle opener (12).

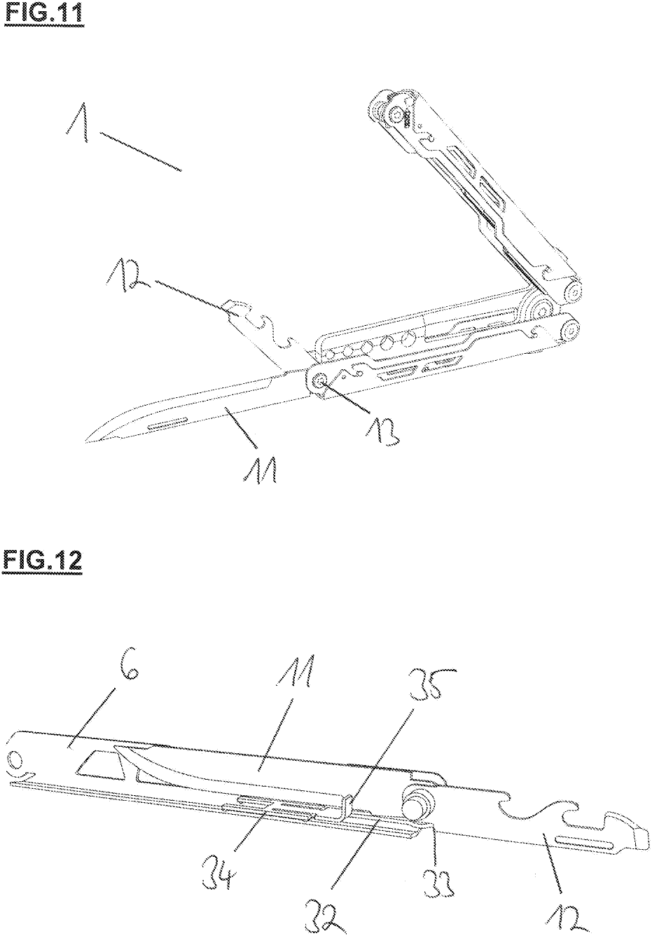

FIG. 12 illustrates a detail-specific view in the region of the swing-action tools (3a) from FIG. 11. The figure here shows an arresting spring (32), which performs a number of functions in respect of the swing-action tool (3a). On the one hand, the arresting spring (32) has a prestressing function such as to subject the swing-action tools (3a), provided these are not fully swung out, to a force in the direction of the swung-in position. This secures the swing-action tools (3a) against undesirable swing-out operation. Furthermore, the arresting spring (32), together with a stopping edge (33) on the respective swing-action tool (3a), realizes a mechanical stop or end point for the swing-action tools (3a) in the swung-out state.

For fastening purposes in the main shell (6) of the barbecue utensil (1), the arresting spring (32) has a main body (34), which in the present case is H-shaped and can be latched into corresponding mounts in the main shell (6) via small studs.

The arresting spring (32) also has a spacer element (35) which projects into the interior space of the main shell (6) and, along with corresponding devices, serves as a bearing means for the barbecue tongs (4).

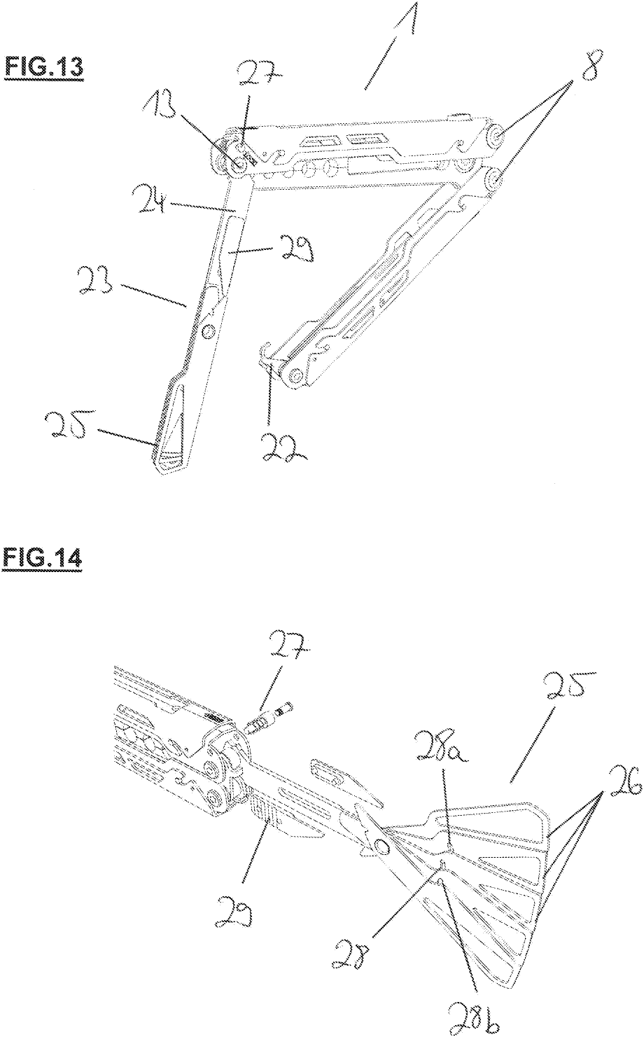

FIG. 13 shows the barbecue utensil (1) in a partially swung-open state. Two aspects of the barbecue utensil (1) are evident here. On the one hand, the barbecue utensil (1) has a housing lock (22), which is designed in the form of a hook and by means of which the housing halves can be fixed in a swung-closed state.

On the other hand, a further swing-action tool (3b), designed in the form of a turner (23), has been partially swung out of the barbecue utensil (1). The turner (23) has a stem (24) and a head (25).

The details of the turner (23) can be seen in FIG. 14, which shows a partially dismantled turner (23) with a number of individual parts.

The head (25) of the turner (23) has a plurality of, in the present case five, head segments (26), which can be folded closed and open in a fan-like manner.

The stem (24) of the turner (23) is fastened on the housing (2) by way of an axis-of-rotation element (13) of the barbecue utensil (1), wherein the position of the turner in a swung-in state and in a swung-out state can be arrested with the aid of an arresting device (27), in which case undesirable swing-in or swing-out operation of the turner (23) is avoided.

The head segments (26) are connected to one another via contact elements (28), so that the movement of one head segment (26) is transmitted to the other head segments (26) when the head segments are being folded open and closed. For this purpose, in the exemplary embodiment illustrated, the head segments (26) have studs (28a) and slots (28b), wherein it is always the case that a stud (28a) of one head segment (26) engages in the slot (28b) of an adjacent head segment (26). As soon as one head segment (26) has been pivoted in relation to the adjacent head segment (26) to the extent where the stud (28a) has reached the end of the slot (28b) of the respective contact element (28), the adjacent head segment (26) is moved along. This transmission of movement continues correspondingly over all the head segments (26), until the head (25) of the turner (23) is fully fanned out or folded closed.

In order to assist the fanning-out operation, the turner (23) has a sliding element (29), which acts at the same time as a fixing device.

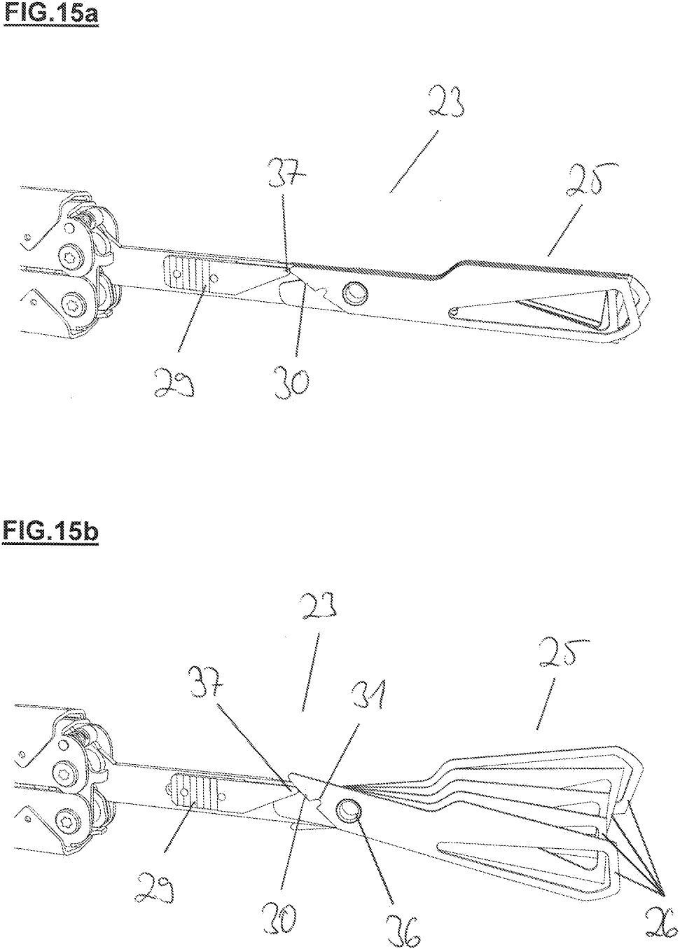

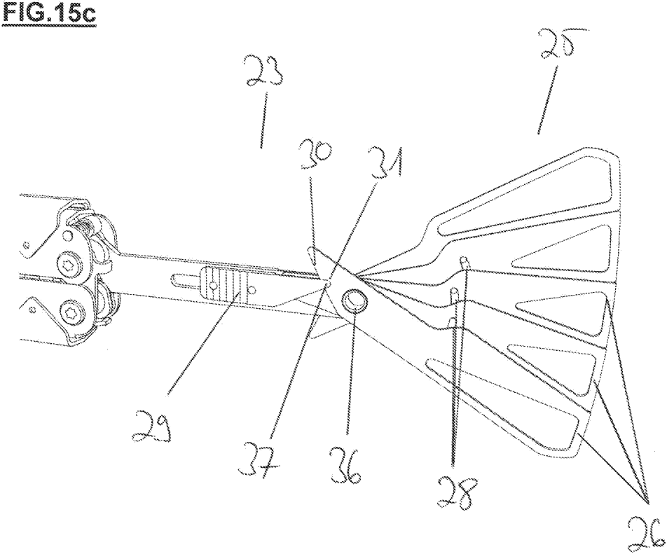

The function of the sliding element (29) or of the fixing device is illustrated in FIGS. 15a, 15b and 15c.

The sliding element (29) is guided linearly in the region of the stem (24) of the turner (23) and, on its side which is directed toward the head (25), has a tip (37), which is positioned in the same plane as an external head segment (26). At its end which is directed toward the sliding element (29), the external head segment (26) has a sliding edge (30). If the sliding element (29), then, is displaced in the direction of the head (29), the tip (37) slides along the sliding edge (30). The progression of the sliding edge (30) in relation to the axis-of-rotation element (36) of the head segments (26) causes the external head segment (26) to be swung out, and the external head segment transmits this movement, with the aid of the contact elements (28), to the rest of the head segments (26). When the fanned-out position of the head (25) has been reached, the tip (37) of the sliding element (29) latches into a latching notch (31) arranged in the sliding edge (30). The head (25) of the turner (23) is thereby fixed in the fanned-out state.

In that embodiment of the invention which is illustrated, the operation of folding the head segments (26) closed in order for the turner (23) to be stowed in the housing (2) of the barbecue utensil (1) takes place by the head segments (26) being pushed together manually once the sliding element (29) has been moved out of the fixing position in the latching notch (31) by a movement away from the head (25).

In alternative embodiments of the invention, the sliding element (29) is also connected mechanically to the head segments (26) in order for the latter to be folded closed.

While specific embodiments of the invention have been shown and described in detail to illustrate the inventive principles, it will be understood that the invention may be embodied otherwise without departing from such principles.

I claim:

1. A barbecue utensil, comprising: a housing configured to be usable as a handle; and having at least one tool that is stowable in the housing, wherein the at least one tool is a foldable turner for turning food, wherein the turner has a head with a surface area that is reduced by a folding function for stowage purposes and is increased by the folding function in order for the turner to be used for turning food.

2. The barbecue utensil according to claim 1, wherein the head of the turner has a plurality of head segments that are foldable open and closed in a fan-like manner.

3. The barbecue utensil according to claim 2, wherein the head segments are connected to one another by contact elements so that all the head segments are fanned out by actuation of a single one of the head segments.

4. The barbecue utensil according to claim 2, further comprising a fixing device that fixes the head segments of the turner in a fanned-out position.

5. The barbecue utensil according to claim 1, wherein the housing has two main shells that are U-shaped profiles and that are swingable closed and swung open via at least one housing hinge, wherein the main shells form a stowage space for tools that are swing-action tools.

6. The barbecue utensil according to claim 5, further comprising a covering shell arranged on an outside of at least one of the main shells to form a second stowage space between the main shell and the covering shell for a sliding tool.

7. The barbecue utensil according to claim 6, wherein the covering shell is releasably connected to the main shell so that the tool located therebeneath is removable.

8. The barbecue utensil according to claim 1, wherein the at least one tool includes at least one sliding tool configured as a sliding knife, a fork or a skewer.

9. The barbecue utensil according to claim 1, wherein the at least one tool includes at least one swing-action tool, wherein the swing-action tool is assigned an arresting spring.

10. The barbecue utensil according to claim 9, wherein the a swing-action tool is barbecue tongs.

11. The barbecue utensil according to claim 10, further comprising bearing shoulders for central alignment of the barbecue tongs in a swung-closed state of the barbecue utensil.
